(19) United States
(12) Patent Application Publication
(10) Pub. No.: US 2012/0217892 A1
(43) Pub. Date: Aug. 30, 2012

(54) LED CURRENT PWM DIMMING MODULE

(75) Inventors: Yik Lun Chu, Hong Kong (HK); Richard Fong, Hong (HK)

(73) Assignee: GRE ALPHA ELECTRONICS LTD., Hong Kong (HK)

(21) Appl. No.: 13/470,304

(22) Filed: May 12, 2012

Related U.S. Application Data
(63) Continuation-in-part of application No. 13/031,633, filed on Feb. 22, 2011.

(51) Int. Cl. H05B 37/00

(52) U.S. Cl. 315/250

(57) ABSTRACT

An LED current PWM dimming module comprising: an input voltage regulator for regulating the constant direct current supplied by the LED driver power supply in order to maintain a fixed and stable supply voltage source to a timer-oscillator and a DC-DC buck converter; the timer-oscillator for generating a repetitive square wave electrical output to be fed to the DC-DC buck converter; and the DC-DC buck converter for producing a driving pulse-width-modulated (PWM) current output to power one or more LEDs from the repetitive square wave electrical output; wherein the timer-oscillator receives a control signal from an external dimming controller and adjusts the repetitive square wave electrical output frequency and duty cycle accordingly; and wherein the driving PWM current output frequency and duty cycle being varied in an open-loop manner.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to light emitting diode (LED) drivers. More specifically, the present invention relates to the brightness dimming control circuitry of LED.

### BACKGROUND

Traditionally, incandescent and fluorescent lights have been the primary source of artificial illumination. However, significant advances in the light emitting diode (LED) technology have made the light output of LEDs not only for indicator applications but also sufficient for general illumination.

LEDs are a type of semiconductor device requiring direct current (DC) electricity input source for operation. Conventional LED lighting unit comprises a LED driver power supply, a dimming module, a dimming controller, and arrays of LEDs. The LED driver power supply takes an external electricity power input source and convert to a constant direct current output, feeding the dimming module and in turn the LEDs. For land and building use, the external power source is usually an alternative current electricity power source. In such conventional LED lighting unit, one limitation is that the choice of LED driver power supply used must be carefully matched with the capacity of the LEDs, as the maximum current driving the LEDs is fixed by the LED driver power supply based on its type and capacity.

One common type of dimming module is the low frequency Pulse-width Modulator (PWM). The average value of current fed to the load LEDs is controlled by turning a switch between the power input and load on and off at a fast pace. The longer the switch is on compared to the off periods, the higher the current supplied to the load is. Thus, the current supplied to the LEDs is Iₘᵢₙ≦I_{LED}≦I_{Driver}, where I_{LED} is the current supplied to the LED; I_{Driver} is the direct current output of the LED driver power supply; and Iₘᵢₙ is minimum current that the PWM dimming module can output. The switching frequency of this type of PWM dimming module is usually controlled by a separate dimming controller. One disadvantage of this configuration is the complicated non-standardized wiring and installation. Another disadvantage is the relatively high cost associated with a customized built-in power supply in the dimming module for powering the LEDs. Even in the case where the power supply and the dimming module are separate components, both must be manufactured with compatible electrical specification. Therefore, there is an unmet demand for an inexpensive LED dimming module which allows simple installation and interoperability with power supplies of various capacities.

The U.S. Patent Application Publication No. 2007/0097043 discloses a LED driver aims to improve the efficiency of LED by adjusting the feeding current in correlation with the LED temperature. In this disclosure, although a control circuit is used to adjust the feeding current to the LED, this control circuit is to maintain a constant chromaticity and/or luminosity of the LED and is not meant to be used to adjust the brightness of the LED.

The U.S. Pat. No. 6,586,890 discloses a driver circuit for LEDs using pulse width modulation (PWM). It also uses current feedback to adjust power to the LEDs and provides a full light and a dim mode. The disclosed driver circuit aims to provide good regulation and efficiency while the current feedback is to maintain operation at the LEDs' nominal current. However, the disclosed driver circuit has a complex current feedback loop and requires relatively high costing PWM control ICs.

### SUMMARY

It is an objective of the presently claimed invention to provide a low-cost integrated LED current PWM dimming module that eliminates complicated wiring and installation when coupling a separate dimming controller. It is a further objective of the presently claimed invention to provide interoperability with a wide variety of dimming controllers. It is a still further objective of the presently claimed invention to provide interoperability with external LED driver power supplies of various capacities.

In accordance with various embodiments, the presently claimed LED current PWM dimming module is a standalone component in an LED lighting system. The PWM dimming module is coupled with a constant voltage and current LED driver power supply, a dimming controller or panel, and an LED or one or more arrays of LEDs.

In accordance with one embodiment, the presently claimed LED current PWM dimming module is a self-contained component with all of its internal sub-components enclosed in a water-proof enclosure with only one set of two electrical wires for connecting the LED driver power supply, one set of three electrical wires for connecting the dimming controller, and one set of two electrical wires for LED feeding current output connection protruding from the water-proof enclosure.

In accordance with various embodiments, the presently claimed LED current PWM dimming module can provide an automatic compliance LED voltage feeding from one LED to a maximum number of LEDs where the aggregate voltage drop is within the range of Vᵢₙ−2V, where Vᵢₙ is the feeding voltage to the one or more LEDs that are connected in series. In this embodiment, the maximum LED driving current is adjustable according to the LED drive provision.

In accordance with another embodiment, the presently claimed LED current PWM dimming module includes the features of over current protection (OCP), and short circuit protection.

In accordance with various embodiments, the presently claimed LED current PWM dimming module can provide an input voltage range of 12 to 28V; an output voltage range of 2.7 to 28V; a maximum LED driving current of 700 mA; a typical power efficiency of 90%; a LED driving current regulation of +/−5%; a PWM dimming frequency range of 100 Hz to 10 kHz; and a dimming ratio range from 1:100 to 1:10000. Having a lower PWM dimming frequency range is desirable in lamination application. For typical PWM dimming frequency range of 1 kHz and up, the dimming ratio is lowered in order to avoid visual blink problem, particularly in high-speed video capturing under the LED-lighted environment. At lower dimming frequency range allows a higher the dimming ratio and in turn provides a smoother and better dimming linearity for lamination.

### BRIEF DESCRIPTION OF THE DRAWINGS

Embodiments of the invention are described in more detail hereinafter with reference to the drawings, in which

FIG. 1 shows a block diagram schematically illustrating a LED lighting system including an embodiment of a LED current PWM dimming module;

FIG. 2 shows a block diagram schematically illustrating the internal sub-components of an embodiment of a LED current PWM dimming module; and

FIG. 3 illustrates schematically the circuitry of an embodiment of a LED current PWM dimming module.

### DETAILED DESCRIPTION

In the following description, system and apparatus of LED current PWM dimming module and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

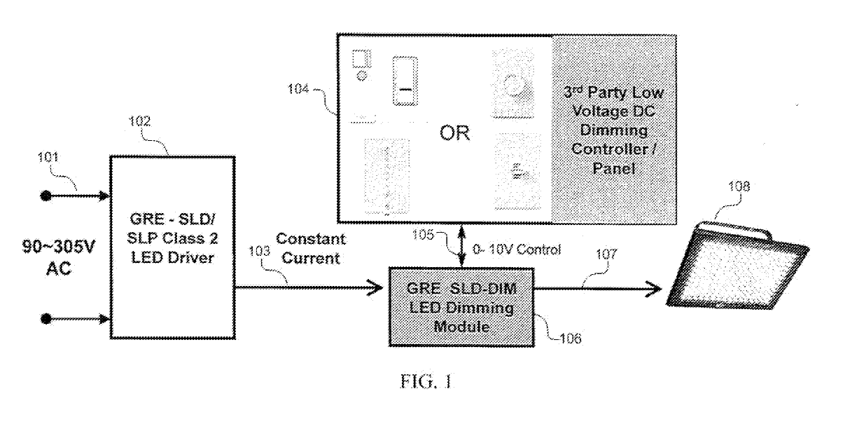

Referring to FIG. 1. In accordance with various embodiments the presently claimed LED current PWM dimming module 106 connects a dimming controller 104 via an electrical wire connection 105 providing a varying control voltage signal to the LED current PWM dimming module 106. The dimming controller 104 can be one of many existing commercially available light-dimming controllers including but not limited to mechanical-analog dial type controls, mechanical-analog slider type controls, electronic-digital type controls, and electronic remote type controls.

Due to the relatively small size of the LED current PWM dimming module 106, it can be deployed and installed flexibly in many situations including in-wall installation where the LED current PWM dimming module 106 can be secured behind the dimming controller 104 with only the front face panel of the controller is exposed to users.

The electrical wire connection 103 connects to an LED driver power supply 102 supplying constant direct current to the LED current PWM dimming module 106. The LED current PWM dimming module 106 provides the driving PWM current output to the LEDs 108 through the electrical wire connection 107. The LED current PWM dimming module 106 can supply a driving PWM current output with an automatic compliance LED feeding voltage (V_{LED}) depending on the LED drive provision.

In accordance with one embodiment, the LED current PWM dimming module 106 features a low frequency, which ranges from 360 Hz to 440 Hz, pulse driving PWM current output.

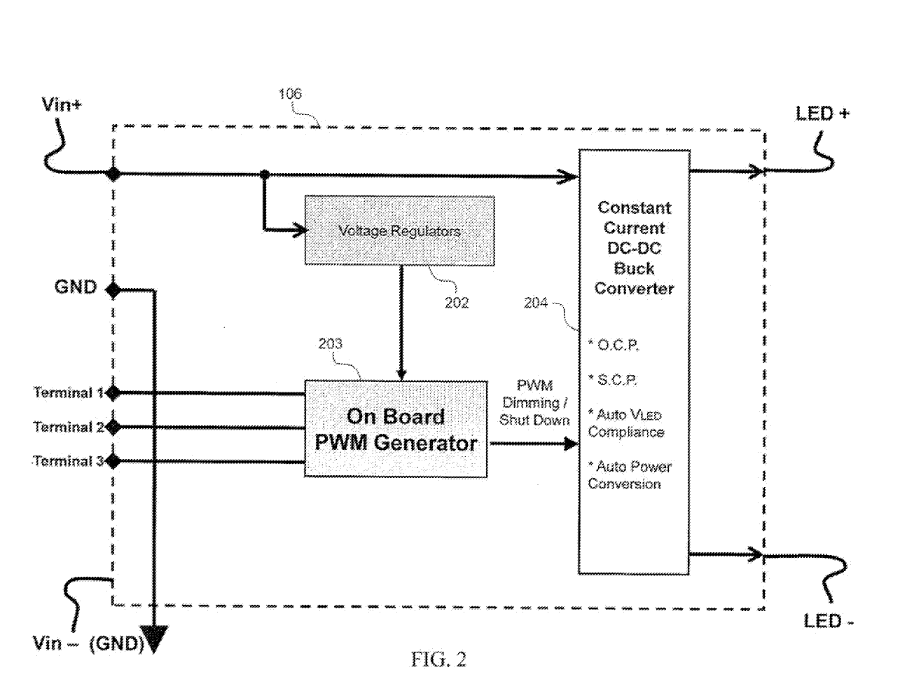

Referring to FIG. 2. In accordance with one embodiment, the PWM dimming module 106 includes an onboard PWM generator 203 for generating a PWM current to the constant current DC-DC buck converter 204. The PWM dimming module also includes a voltage regulator 202 for maintaining a constant voltage level on the input voltage (Vᵢₙ) from the external LED driver power supply.

Vᵢₙ and the PWM current are fed into the DC-DC buck converter 204 for generating the driving PWM current output to one or more LEDs or arrays of LED. Besides providing the voltage step-down on Vᵢₙ to achieve an automatic compliance LED feeding voltage (V_{LED}) on the driving PWM current output, the DC-DC buck converter 203 also provides the circuitries for over-current protection (OCP), short-circuit protection.

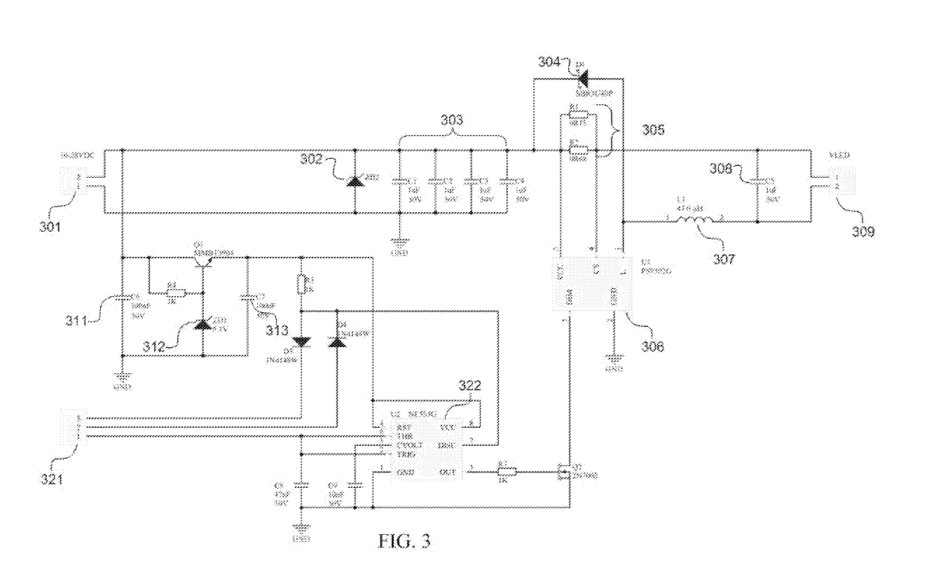

FIG. 3 depicts the circuit diagram of an exemplary implementation of the LED current PWM dimming module 106. In this circuit, the input constant DC voltage source (Vᵢₙ) is fed through connector 301 to a first voltage regulator circuit comprising a voltage regulator diode ZD2 302 and capacitors C1-C4 303 connected in parallel, providing a fixed and stable supply voltage to an LED Driver IC U1 306.

The input constant DC voltage source (Vᵢₙ) is fed also to a second voltage regulator circuit comprising capacitors C6 311 and C7 313, and a voltage regulator diode ZD1 312 connected in parallel, providing a fixed and stable supply voltage and reset signal to the timer-oscillator U2 322.

The timer-oscillator U2 322 obtains its trigger and threshold input signal from the control voltage source (DC-Ctrl) through pin 1 of the connector 321. The frequency and duty cycle of the oscillating electrical output generated by timer-oscillator U2 322 vary according to the DC-Ctrl voltage level. Unlike conventional PWM dimming circuits, the circuitry of the presently claimed LED current PWM dimming module does not require a microcontroller or feedback loop from the LEDs for adjusting the PWM current output frequency and duty cycle. The presently claimed LED current PWM dimming module relies primarily on the timer-oscillator U2 322 to generate a frequency/duty cycle-adjustable PWM current. This open-loop PWM circuit design is simpler and less expensive than the conventional closed-loop PWM circuit design.

The oscillating electrical output generated from the timer-oscillator U2 322 is then fed to the LED Driver IC U1 306 to be repeated for producing the driving PWM current output at the connector 309. The rectifier D1 304, resistors R1 and R2 305, inductor L1 307, capacitor C5 308, and the LED Driver IC U1 306 combined to form a DC-DC buck converter for providing the driving PWM current output with an automatic compliance LED feeding voltage (V_{LED}) depending on the LED drive provision. The use of the LED Driver IC U1 306 provides the electrical isolation between the LED current PWM dimming module and the LEDs, thus functioning as the OCP.

In accordance with one embodiment, the electrical specification of the PWM dimming module is as follows:
Input Voltage (Vᵢₙ) Range: 12˜28V (Vᵢₙ>LED V_{LED}+2V)
Output Voltage (V_{LED}) Range: 2.7˜28V (Auto Compliance up to V_{LED})
Max. LED Current: 700 mA
Power Efficiency: Typically 90%
LED Current Regulation: +/−5%
PWM Dimming Frequency: 100 Hz˜10 kHz
Dimming Ratio: 1:10˜01:10000 (@<1 kHz, PWM input)
DC-Ctrl+/−Input Current: 0V@0% LED Current (I_{LED})+10V@100% I_{LED}

In accordance with one embodiment, the LED current PWM dimming module has a water-proof enclosure enclosing all of its internal components with only one set of two electrical wires for connecting the LED driver power supply, one set of three electrical wires for connecting the dimming controller, and one set of two electrical wires for LED feeding current output connection protruding from the water-proof enclosure.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for supplying direct current and brightness dimming function for light emitting diodes (LEDs) comprising:
an LED driver power supply for supplying a constant direct current;
a dimming controller comprising:
a mechanical or electronic means for allowing a user to dim or select a light luminosity level;
one or more LEDs; and
an LED current PWM dimming module comprising:
an input voltage regulator for regulating the constant direct current supplied by the LED driver power supply in order to maintain a fixed and stable supply voltage source to a first circuit and a direct current-to-direct current (DC-DC) buck converter;
the first circuit for generating a repetitive square wave electrical output to be fed to the DC-DC buck converter; and
the DC-DC buck converter for producing a driving pulse-width-modulated (PWM) current output to power the one or more LEDs from the repetitive square wave electrical output;
wherein the first circuit receives a control signal from the dimming controller and adjusts the repetitive square wave electrical output frequency and duty cycle accordingly; and
wherein the driving PWM current output frequency and duty cycle being varied in an open-loop manner.

2. The system of claim 1, wherein the DC-DC buck converter comprises:
a second circuit for transferring the repetitive square wave electrical output to produce the driving PWM current output using light waves, providing coupling with electrical isolation between the LED current PWM dimming module and the LEDs; wherein the electrical isolation functions as an over-current protection (OCP).

3. The system of claim 1, wherein the LED current PWM dimming module further comprises a short circuit protection (SCP) circuit.

4. The system of claim 1, wherein the LED current PWM dimming module further comprises a water-proof enclosure enclosing components of the LED current PWM dimming module.

5. A devise for varying brightness of a light emitting diode (LED) by supplying to the LED a PWM electric current with adjustable frequency and duty cycle, comprising:
an input voltage regulator for regulating a constant direct current supplied by an external LED driver power supply in order to maintain a fixed and stable supply voltage source to a first circuit and a direct current-to-direct current (DC-DC) buck converter;
the first circuit for generating a repetitive square wave electrical output to be fed to the DC-DC buck converter; and
the DC-DC buck converter for producing a driving pulse-width-modulated (PWM) current output to power one or more LEDs from the repetitive square wave electrical output;
wherein the first circuit receives a control signal from an external dimming controller and adjusts the repetitive square wave electrical output frequency and duty cycle accordingly; and
wherein the driving PWM current output frequency and duty cycle being varied in an open-loop manner.

6. The device of claim 5, wherein the DC-DC buck converter comprises:
a second circuit for transferring the repetitive square wave electrical output to produce the driving PWM current output using light waves, providing coupling with electrical isolation between the LED current PWM dimming module and the LEDs; wherein the electrical isolation functions as an over-current protection (OCP).

7. The device of claim 5, further comprising a short circuit protection (SCP) circuit.

8. The device of claim 6, further comprising a water-proof enclosure enclosing components of the LED current PWM dimming module.
